(19) United States
(12) Patent Application Publication
(10) Pub. No.: US 2007/0009824 A1
(43) Pub. Date: Jan. 11, 2007

(54) Electrostatic charge image developing toner

(75) Inventor: Hiroto Kidokoro, Tokyo (JP)

Correspondence Address: ARMSTRONG, KRATZ, QUINTOS, HANSON & BROOKS, LLP, 1725 K STREET, NW, SUITE 1000, WASHINGTON, DC, 20006, US

(73) Assignee: AEON CORPORATION, Tokyo (JP)

(21) Appl. No.: 10/571,197

(22) PCT Filed: Jun. 11, 2004
(86) PCT No.: PCT/JP04/08203

§ 371 Date: Mar. 9, 2006

(30) Foreign Application Priority Data
Sep. 12, 2003 (JP) 2003-320972

(51) Int. Cl. G03G 9/08

(52) U.S. Cl. 430/108.4; 430/111.41; 430/108.8

(57) ABSTRACT

The toner for developing an electrostatic latent images of the present invention, comprising colored resin particles containing at least a binder resin and a colorant wherein said colored resin particles have a volume average particle diameter (Dv) in the range from 4 to 10 μm and an average circularity in the range from 0.930 to 0.995 and, a zeta potential (E1) of the toner after laid still under a condition at a temperature of 23° C. and a humidity of 50% for one day and night is in the range from −50 to −10 mV and a difference is less than 5 mV between a zeta potential (E2) of the toner after laid still under an environment of temperature of 50° C. and humidity of 80% for two weeks and El. According to the present invention, there are provided toners for developing electrostatic images, which forms images without losing quality due to environmental changes and also has excellent storage stability and flowability.

### TECHNICAL FIELD

The present invention relates to a toner for developing electrostatic latent images and more specifically to a toner for developing electrostatic latent images, which forms an image without losing quality due to environmental changes and has excellent storage stability and flowability.

### BACKGROUND ART

In an image forming apparatus such as an electrophotographic apparatus and electrostatic recording apparatus, an electrostatic latent image formed on a photoconductive member is first developed with a toner. After the toner image formed is then transferred to a transfer medium such as paper or OHP film, the transferred toner image is fixed thereto by heating, pressing and/or use of solvent vapor.

Currently, the image forming apparatus is becoming more and more advanced, and thus is demanded achievement of high speed as well as high resolution by a method of forming an electrostatic latent image by a laser. Accordingly, in addition to achieving a small particle diameter and a sharp particle diameter distribution for responding to the high resolution requirement, toners are required to have low-temperature fixing ability so as to correspond with high-printing speed model printers. On the other hand, in recent years, the image forming apparatus has been gradually used under high temperature and high humidity conditions. Accordingly, improving stability of image density, flowability and storage stability of a toner has been required.

In such the image forming apparatus, a pulverized toner has been mainly employed. The pulverized toner is produced in such a manner that a thermoplastic resin including a colorant, a charge control agent and the like is melt-blended to be uniformly dispersed, and then the dispersion is subjected to pulverizing and classification. However, the pulverized toner has a difficulty in controlling its particle diameter, further a classification process is required, causing complex production process. And, since fine powder remains on the surface of the pulverization toner, a charge amount of the toner is changed resulting in deterioration of image quality. In addition, the pulverized toner excellent in flowability and storage stability cannot be obtained.

In order to solve such the problems, toners produced by a polymerization method has been proposed. For instance, Japanese Patent Application Laid-Open Hei 6-273977 proposed by the inventors discloses a production method of a toner for developing electrostatic latent images. The proposed method comprises a process in which after wet pulverizing a polyolefin wax in a polymerizable monomer composition, a colorant is added to the polymerizable monomer composition, and the polymerizable monomer composition is mixed to disperse the colorant therein and then to be suspension polymerized. The toner produced by this method is excellent in fixing ability, developing ability and durability, causing no filming on a photoconductive member and a developing blade. However, it is required for the toner to further improve durability under high temperature and high humidity conditions.

As mentioned above, a toner employed for a high-printing speed model printer is required to have low-temperature fixing ability. Generally, in order for the toner to have low-temperature fixing ability, the toner is designed to contain a large amount of softener. In such a case, if the toner is stored for the long period, an external additive may be embedded in a binder resin. As a result, problems, such as deteriorations in storage stability of the toner and also image quality, arise. In order to solve the problems, a polymerized toner being encapsulated with a capsule has been proposed. For instance, Japanese Patent Application Laid-Open Hei 11-72949 proposed by the inventors discloses a developer comprising a polymer particle and an external additive. In the developer, an extracted liquid with water from the developer by a specific manner has pH from 4 to 7. The developer disclosed in the literature allows low-temperature fixing and the encapsulation makes it possible to improve flowability, storage stability for a long period and stability in charging ability of the toner. However, in recent years, a toner has been employed under high temperature and high humidity conditions and thus is required to further improve the above abilities. Accordingly, in a case which a conventionally used encapsuled toner comprising a large amount of parting agent having low softening point and a charge control resin having moisture-absorption characteristics is stored over long period under high temperature and high humidity conditions, it is required to prevent lowering of image density and fog on printed image.

On the other hand, Japanese Patent Application Laid-Open Hei 4-217267 discloses a toner for developing electrostatic latent images. The toner particles has a flowability improver which adheres to the surface of the toner particles, in which the flowability improver is controlled in zeta potential under conditions in which hydrogen-ion concentration pH is 5. The literature shows that the toner for developing electrostatic latent images has a small change in frictional charge amount under conditions within a range from low temperature and low humidity conditions to high temperature and high humidity conditions, and can provide high image density and excellent tone. However, the toner for developing electrostatic latent images has problems in high fixing temperature and the like.
Published Patent literature 1: Japanese Patent Application Laid-Open Hei 6-273977,
Published Patent literature 2: Japanese Patent Application Laid-Open Hei 11-72949,
Published Patent literature 3: Japanese Patent Application Laid-Open Hei 4-217267,

Accordingly, the object of the present invention is to provide a toner for developing electrostatic latent images, which has excellent storage stability and flowability and also forms the images without losing image quality due to change in conditions.

The inventor of the present invention carried out an in-depth study to accomplish the object. As a result, he has found this object can be accomplished by using a specific toner comprising a colored resin particle. Here, the colored resin particle is designed to have a volume average particle diameter (Dv) and a circularity within a specific range, respectively. In addition, the toner for developing electrostatic latent images is designed to have a zeta potential within a specific range and also to have a difference in the zeta potentials between before and after leaving the toner in a specific condition for a predetermined period within a specific range.

The present invention has been accomplished based on the above finding and provides a toner containing colored resin particles comprising at least a binder resin and a colorant. The colored resin particles has a volume average particle diameter (Dv) in the range from 4 to 10 μm and an average circularity in the range from 0.930 to 0.995 and, a zeta potential (E1) of the toner after laid still under a condition at the temperature of 23° C. and the humidity of 50% for one day and night is in the range from −50 to −10 mV and a difference of less than 5 mV between a zeta potential (E2) of the toner after laid still under an environment of temperature of 50° C. and humidity of 80% for two weeks and E1.

The above toner for developing electrostatic latent images has low-temperature fixing ability as well as excellent storage stability and flowability.

Soluble component in tetrahydrofran of the above toner for developing electrostatic latent images has an acid value of 4 mgKOH/g or less.

The above toner for developing electrostatic latent images preferably contains a multifunctional ester compound having a hydroxyl value (a) of 4 mgKOH/g or less as a parting agent. And, the product of an added amount (b) of the parting agent per 100 parts by weight of the binder resin and the hydroxyl value (a) is 40 or less.

The above toner for developing electrostatic latent images preferably further contains a charge control resin having a number average molecular weight in the range from 3,000 to 30,000 and an acid value in the range from 0.03 to 15 mgKOH/g as a charge control agent.

### EFFECT OF THE INVENTION

According to the present invention, a toner forming images without losing image quality due to environmental changes as well as having excellent storage stability and flowability can be provided.

### BEST MODE FOR CARRYING OUT THE INVENTION

A toner for developing electrostatic latent images according to the present invention is described in detail below.

A toner for developing electrostatic latent image of the present invention comprises colored resin particles containing at least a binder resin and a colorant. And, the colored resin particles preferably further contain a charge control resin and an external additive.

Specific examples of the binder resin include resins such as polystyrene, styrene-butyl acrylate copolymers, polyester resins and epoxy resins, which are conventionally used for the toner.

As the colorant, any pigments and dyes can be employed, in addition to carbon black, titanium black, magnetic powder, oil black, and titanium white. Carbon black having a primary particle diameter in the range from 20 to 40 nm is preferably used as a black colorant. The particle diameter within this range is preferred because such carbon black can be uniformly dispersed in the toner and fog in the resulting printed image can decrease.

For a full color toner, a yellow colorant, a magenta colorant and a cyan colorant are generally used.

As the yellow colorant, there can be mentioned; compounds such as azo pigments, and condensed polycyclic pigments. Specific examples of the yellow colorant include pigments such as C.I. Pigment Yellow 3, 12, 13, 14, 15, 17, 62, 65, 73, 74, 83, 90, 93, 97, 120, 138, 155, 180, 181, 185 and 186.

As the magenta colorant, there can be mentioned; compounds such as azo pigments, and condensed polycyclic pigments. Specific examples of the magenta colorant include pigments such as C.I. Pigment Red 31, 48, 57, 58, 60, 63, 64, 68, 81, 83, 87, 88, 89, 90, 112, 114, 122, 123, 144, 146, 149, 150, 163, 170, 184, 185, 187, 202, 206, 207, 209, 251, and C.I. Pigment Violet 19.

As the cyan colorant, there can be mentioned; cupper phthalocyanine compounds and their derivatives, anthraquinone compounds and the like. Specific examples of the cyan colorant include pigments such as C.I. Pigment Blue 2, 3, 6, 15, 15:1, 15:2, 15:3, 15:4, 16, 17, and 60.

An amount of the colorant is preferably from 1 to 10 parts by weight per 100 parts by weight of the binder resin.

As the charge control agent, charge control agents used in conventionally used toners can be employed without limitation. Among the charge control agents, a charge control resin is preferable, because charge control resins have high compatibility with binder resins, are colorless, and can provide a toner with a stable charging property even when it is used in high-speed continuous color printing. As the positive charge control resin, there can be mentioned; quaternary ammonium (salt) group-containing copolymers produced in accordance with the descriptions of Japanese Patent Application Laid-Open Nos. Sho 63-60458, Hei 3-175456, Hei 3-243954, and Hei 11-15192, and sulfonic acid (salt) group-containing copolymers produced in accordance with the descriptions of Japanese Patent Application Laid-Open Nos. 1989-217464 and 1991-15858.

In the present invention, the sulfonic acid group-containing copolymers are preferably used, and an amount of the monomer unit having the sulfonic acid (salt) group is preferably 0.1 to 10% by weight, more preferably 0.3 to 8% by weight. If the content of the monomer unit is within this range, a charge amount of the resulting toner for developing electrostatic latent images is easy to control, and the generation of fog in printed image developed using the toner can be minimized.

Preferred as the charge control resin is that having a number average molecular weight from 3,000 to 50,000, more preferably from 3,000 to 35,000, most preferably from 5,000 to 20,000. If the charge control agent has a number average molecular weight of less than 3,000, offset occurs on printed image; if the charge control agent has a number average molecular weight of more than 50,000, fixing ability of the resulting toner may deteriorate.

A glass transition temperature of the charge control resin is preferably from 40 to 80° C., more preferably from 45 to 75° C., most preferably from 45 to 70° C. If the glass transition temperature of the charge control resin is lower than 40° C., the storage stability of the resulting toner may deteriorate. If the glass transition temperature exceeds 80° C., fixing ability of the resulting toner may lower.

The charge control resin preferably has an acid value in the range from 0.03 to 15 mgKOH/g, more preferably in the range from 0.2 to 10 mgKOH/g. If the acid value of the charge control resin is less than 0.03 mgKOH/g, an image density of printed image developed using the resulting toner may be lowered; if the acid value is more than 15 mgKOH/g, fog may be generated on the printed image.

An amount of the charge control agent is generally from 0.01 to 10 parts by weight, preferably from 0.3 to 5 parts by weight, per 100 parts by weight of the binder resin.

As the parting agent, there can be mentioned; polyolefin waxes such as low molecular weight polyethylene, low molecular weight polypropylene and low molecular weight polybutylene; natural plant waxes such as candelilla, carnauba, rice, wood wax and jojoba; petroleum waxes such as paraffin, microcrystalline and petrolatum, as well as waxes modified therefrom; synthetic waxes such as Fischer-Tropsch wax; and multifunctional ester compounds such as pentaerythritol tetrastearate, pentaerythritol tetrapalmitate, dipentaerythritol hexapalmitate, pentaerythritol tetramyristrate and dipentaerythritol hexamyristate.

These parting agents may be used either singly or in any combinations thereof.

Among these parting agents, synthetic waxes and multifunctional ester compounds are preferred. Furthermore, multifunctional ester compounds are more preferred, which show an endothermic peak temperature within the range from, preferably 30° C. to 150° C., more preferably from 40° C. to 100° C., most preferably from 50° C. to 80° C., measured with a DSC curve by means of a differential scanning calorimeter at rising temperature, because a toner excellent in a balance between fixing property and peeling property during fixing is obtained. In particular, those having a molecular weight of 1,000 or more and soluble in styrene at 25° C. in an amount of 5 parts by weight or more based on 100 parts by weight of styrene, and having an acid value of 10 mg KOH/g or less, are even more preferred, because it exhibits a distinguished effect in lowering a fixing temperature. As the multifunctional ester compounds, dipentaerythritol hexamyristate and pentaerythritol tetrastearate are particularly preferred. The endothermic peak temperature shows a value measured by means of ASTM D3418-82.

The parting agent preferably has a hydroxyl value of 4 mgKOH/g or less, more preferably 3 mgKOH/g or less. If the hydroxyl value of the parting agent is more than 4 mgKOH/g, fog may be generated on printed image.

An amount of the parting agent is generally from 3 to 20 parts by weight, preferably from 5 to 15 parts by weight, per 100 parts by weight of the binder resin.

And, when an added amount of the parting agent per 100parts by weight of the binder resin is set to “b” and when an acid value (mgKOH/g) of the parting agent is set to “a”, a product (a×b) of “a” and “b” is preferably less than 40, more preferably less than 30. If the product of “a” and “b” is larger than 40, fog may be generated on printed image.

The colored resin particles constituting the toner for developing electrostatic latent images of the present invention may be so-called core-shell structured (also called “capsule type”) particles, in which the polymer for an inner layer (an core layer) of the particle is different from the binder resin for an outer layer (a shell layer) of the particle. The core-shell structured particles is preferred because it can provide a favorable balance between lowering of the fixing temperature and prevention of aggregation of the toner during storage by covering the low softening point substance as the inner layer (core layer) with a substance having a higher softening point.

Generally, the core layer of the core-shell structured particles is composed of the aforementioned binder resin, colorant, charge control resin and parting agent, while the shell layer is composed of the binder resin alone.

The proportion by weight of the core layer to the shell layer of the core-shell structured particles is not particularly limited, but is generally in the range of from 80/20 to 99.9/0.1.

By using the shell layer in this proportion, good storage stability and good low temperature fixing ability of the toner for developing electrostatic latent images can be fulfilled at the same time.

An average thickness of the shell layer of the core-shell structured particles may be generally from 0.001 to 1.0 m, preferably from 0.003 to 0.5 μm, more preferably from 0.005 to 0.2 μm. If the thickness is too large, fixing ability of the resulting toner may decline. If it is too small, storage stability of the resulting toner may decline. The core particle constituting the colored resin particle of the core-shell structured particles does not necessarily have all of its surface covered with the shell layer. The surface of the core particle may partly be covered with the shell layer.

A diameter of the core particles and a thickness of the shell layer of the core-shell structured particles can be measured by directly measuring the diameter and thickness of particles which are chosen randomly from photographs taken with an electron microscope, if possible. When it is difficult to observe both of the core and shell layer by an electron microscope, they can be calculated based on the diameter of the core particle and the amount of the monomer used for forming the shell layer at the time of producing the toner.

The colored resin particles constituting a toner for developing electrostatic latent images according to the present invention has a volume average particle diameter Dv from 4 to 10 μm, preferably from 5 to 8 μm. If the Dv is less than 4 μm, flowability of the resulting toner lowers, resulting in insufficient transferring and cleaning abilities and thus causing fog on printed image. On the other hand, if the Dv is larger than 10 μm, reproducibility of thin lines may be lowered.

The colored resin particles constituting the toner for developing electrostatic latent images according to the present invention preferably has a ratio (Dv/Dp) of the volume average particle diameter (Dv) to a number average particle diameter (Dp) from 1.0 to 1.3, preferably from 1.0 to 1.2. If the Dv/Dp exceeds 1.3, fog may be generated on printed image.

The volume average particle diameter and the number average particle diameter of the colored resin particles can be measured, for example, by use of MULISIZER (Trade Name, manufactured by Beckman Coulter, Inc.).

The colored resin particle constituting the toner for developing electrostatic latent images according to the present invention has an average circularity from 0.930 to 0.995, preferably from 0.950 to 0.995, as measured by a flow particle image analyser. If the colored resin particle having a circularity of 0.930 or less is used, reproducibility of thin lines may deteriorate.

Producing a toner for developing electrostatic latent images by means of a phase-transfer emulsion process, a solution suspension process, or a polymerization process (suspension polymerization process, emulsion polymerization method) and the like makes it possible to set the average circularity within the range easily.

In the present invention, the circularity is defined as a ratio of a perimeter of a circle having the same projected area as that of the particle image to a perimeter of the projected area of the particle. And, an average circularity in the present invention is used as a conventional method for quantitatively presenting a shape of a particle, and is an index for showing a degree of surface roughness of the colored resin particle. If the colored resin particles are perfectly spherical, the average circularity equals to 1. And, the larger the roughness of the colored resin particle, the smaller the average circularity. The average circularity (Ca) is calculated using the following formula.

$$Ca = ( {\sum }_{i = 1}^{n} ( Ci ⨯ fi ) ) / {\sum }_{i = 1}^{n} ( fi )$$

In the above formula, n represents the number of particles used for calculating the circularity Ci.

In the above formula, Ci represents the circularity of each particle in a group of particles having a circle equivalent diameter of 0.6 to 400 μm, which is calculated by the following formula from the measured circuit length of each particle.

Circularity (Ci)=circuit length of the circle having the same area with the projection of each particle/perimeter length of the projection of each particle

In the above formula, fᵢ denotes frequency of particle having circularity Cᵢ. The Circularity and the average circularity may be measured with flow type particle projection image analyzers, such as FPIA-1000 (trade name) or FPIA-2000 (trade name), manufactured by Sysmex Corporation.

The toner for developing electrostatic latent images according to the present invention has a zeta potential (E1) from −50 to −10 mV, more preferably from −40 to −20 mV, after laid still under a condition at a temperature of 23° C. and a humidity at 50% for one day and night. If the zeta potential is smaller than −50 mv, fog may be generated on the printed image and the resulting toner may not be transferred fully thereby to remain on the photoconductor. If the zeta potential is larger than −10 mV, image density of printed image may be lowered.

In addition, the toner for developing electrostatic latent image according to the present invention has a difference of 5 mV or less, more preferably 3 mV or less, between a zeta potential (E2) of the toner after laid still under a condition at temperature of 50° C. and a humidity of 80% for two weeks and E1. If the difference between E2 and E1 is larger than 5 mV, fog may be generated on printed image.

A zeta potential is measured by means of, for example, a laser Doppler system known as an electrophoretic light scattering measurement system. When particles dispersed in a liquid are charged, applying voltage to the system causes the particles to move toward an electrode at a moving velocity proportional to the charge amount of the particles. Therefore, measurement of the moving velocity of the particles allows obtaining a zeta potential. In the laser Doppler system, “Doppler effect”, in which when a light or a sonic wave is hit on an moving object and then reflected thereon or scattered, a frequency of the light or the sonic wave is changed according to a velocity of the moving object, is employed for obtaining an electrophoretic velocity (moving velocity) of the particles. When electrophoretic particles are irradiated with a laser beam, a frequency of the scattered light from the particles is sifted due to Dopper effect. And, since the amount of the frequency shift is proportional to the electrophoretic velocity of the particles, measuring the amount of the frequency shift can provide the electrophoretic velocity of the particles.

From the obtained electrophoretic velocity (V) and the electric field (E), an electrical mobility (U) is obtained using the following expression (1).
U=V/E (1)

From the electrical mobility (U), a zeta potential (ζ) is obtained using the following expression (2) (Smoluchowski's expression).

ζ=4πηU/ε (2)

In the expression (2), η and ε show as follows,

η: a viscosity of a solvent;

ε: a dielectric constant of the solvent.

In this description, in order to obtain a zeta potential, a compound liquid (50/50:capacity standard, at 25° C.) of ethanol and ion-exchanged water is employed. η is 0.993 mPa, ε is 52.0.

A value of the zeta potential is a function of the viscosity and the dielectric constant of the solvent as mentioned above. Since the value of the zeta potential is easily affected by ion contained in the solvent or pH of the solvent, the zeta potential is measured under conditions within the range from pH6.5 to 7.5. The ion-exchanged water employed for measuring the zeta potential preferably has an electric conductivity of 10 μS/cm or less, more preferably 1 μS/cm or less. The solvent employed for measuring the zeta potential is not limited the aforesaid ones, but can employ any nonionic solvents which do not dissolve or swell toners for developing electrostatic images and also do not elute additives, such as parting agent, contained in the toner for developing electrostatic latent image. Specific examples of the solvent includes, for example, alcohols such as methanol and isopropanol; ethers such as tetrahydrofuran and diethyl ether; ketons such as acetone; and mix solutions of water and dimethylacetamide, dimethylformamide, dimethyl sulfoxide and the like. In order to measure a zeta potential of the toner for developing electrostatic latent images correctly, a solvent capable of wetting a surface of the toner sufficiently without adhering air bubbles on the surface of the toner when the toner is mixed with the solvent is employed.

In the toner for developing electrostatic latent images according to the present invention, a small amount of ionic substances remaining on the surface or inside of the toner affect to stability of image density. So, an amount of ionic substances being eluted to the medium is preferably small. Accordingly, in the toner for developing electrostatic latent images according to the present invention, an extracted liquid with water from the toner preferably has an electric conductivity σ2 of 20 μS/cm or less, more preferably 10 μS/cm or less. The extracted liquid is obtained in the following manner. First, the toner is dispersed in an ion-exchanged water having an electric conductivity al in the range from 0 to 10 μS/cm, so that a concentration of the toner is 6% by weight. Then, after heating the toner dispersion to the boil for 10 minutes, another ion-exchanged water having an electric conductivity σ1 is added to the resultant toner dispersion to the amount of vaporized water to return the capacity of the toner dispersion to the capacity before the boil and then the resultant toner dispersion is cooled down to the room temperature (about 25° C.) to prepare the extracted liquid. And, a value (σ2-σ1) subtracted σ1 from σ2 is preferably 10 μS/cm or less, more preferably 6 μS/cm or less. If the electric conductivity σ2 is larger than 20 μS/cm, an environmental dependency of a charge amount of the toner becomes large, resulting in lowering image quality due to environmental variations (changes in a temperature and a humidity). Also, if the value σ2-σ1 is larger than 10 μS/cm, an environmental dependency of a charge amount of the toner becomes large, resulting in lowering image quality due to environmental variations (changes in a temperature and a humidity).

Soluble component in tetrahydrofran of the toner for developing electrostatic latent images according to the present invention preferably has an acid value of 4 mgKOH/g or less, more preferably 3 mgKOH/g or less. If the acid value of the soluble components is more than 4 mgKOH/g, fog may be generated on printed image.

The acid value of soluble component of the toner for developing electrostatic latent images in tetrahydrofuran can be measured according to the method described later.

The toner for developing the electrostatic image according to the present invention can be used, as it is, for development in electrophotography. Generally, however, it is preferrable that the toner is used after fine particles having a smaller particle diameter than that of the colored resin particles (the fine particles will be referred to hereinafter as an external additive) are adhered to or buried into the surfaces of the colored resin particles, in order to adjust the charging properties, flowability and storage stability of the toner.

Examples of the external additive are inorganic particles and organic resin particles which works as a plasticizer and an abrasive.

Specific examples of the inorganic particles include silicon dioxide (silica), aluminum oxide (alumina), titanium oxide, zinc oxide, and tin oxide, barium titanate, strontium titanate and the like. Specific examples of the organic resin particles include methacrylic ester polymer particles, acrylic ester polymer particles, styrene-methacrylic ester copolymer particles, styrene-acrylic ester copolymer particles, core-shell structured particles having a core formed of a styrene polymer and a shell formed of a methacrylic ester polymer. Of these particles, the inorganic oxide fine particle, more preferably silica, is preferred. In addition, the inorganic fine particle is preferably subjected to a hydrophobicity-imparting treatment. In fact, a hydrophobicity-imparting treated silica is preferred. Two or more external additives may be used in combination. When the external additives are used in combination, it is preferred to use inorganic fine particles each having a different average particle diameter or inorganic fine particle and organic fine particle in combination.

For the external additive, a silica fine particle having an average primary particle diameter from 5 to 20 nm, more preferably from 7 to 15 nm, is preferably employed. At the same time, a silica fine particle having an average primary particle diameter from 20 to 300 nm, more preferably from 25 to 60 nm, may be used in combination. Furthermore, an inorganic fine particle having an average primary particle diameter from 0.1 to 0.5 μm is more preferably used in addition to the silica fin particles. Using such fine particles at the same time can prevent formation of toner film on the photoconductive member and generation of thin spot on printed image.

The inorganic fine particles such as a silica fine particle are preferably subjected to a hydrophobicity-imparting treatment. A hydrophobicity-imparting treated inorganic fine particle is commercially available. However, it can be obtained by hydrophobicity-imparting treating the inorganic fine particle with a treating agent such as silane coupling agent and silicone oil. A method of the hydrophobicity-imparting treatment includes a method for dropping or splaying the treating agent such as silicon oil to the silica fine particle while stirring the silica fine particle at a high speed, a method for adding and mixing the fine particle to an organic solvent in which the treating agent is dissolved while stirring the organic solvent and then heat-treating, and the like. In the former method, the treating agent may be diluted with an organic solvent and the like.

A degree of hydrophobicity, which is measured using a methanol test, is preferably from 20 to 90%, more preferably from 40 to 80%. If the toner has a degree of hydrophobicity within this range, the toner hardly absorbs moisture under high temperature and high humidity conditions thereby to obtain sufficient abrasion characteristic.

An amount ratio of the external additives (alone or total) is not limited but is generally from 0.1 to 6 parts by weight per 100 parts by weight of the colored resin particle. To adhere the external additive to the colored resin particle, generally, the colored resin particle and the external additive are charged to a mixer such as a HENSCHEL mixer and stirred.

The toner for developing electrostatic latent image according to the present invention can be produced by controlling kind and amount of a charge control resin and a parting agent, and kind of the monomer in a toner producing method such as a polymerization method (a suspension polymerization method, an emulsion polymerization method and the like), a dissolution suspension method, a pulverization method and the like.

Next, a method for producing a colored resin particle constituting the toner for developing electrostatic latent images by means of a suspension polymerization method will be described in detail. The colored resin particle constituting the toner for developing electrostatic latent image according to the present invention is produced in the following manner. First, a colorant, a charge control agent, a parting agent, a chain transfer agent and other additives are dissolved or dispersed in a polymerizable monomer, which is a raw material of the binder resin, and then the polymerizable monomer composition is added and mixed to an aqueous dispersion medium containing a dispersion stabilizer. After mixing uniformly, a polymerization initiator is added to the aqueous dispersion medium containing the polymerizable monomer composition, and the aqueous dispersion medium containing the polymerizable monomer composition is treated with a high speed stirrer (homogenizer) to form droplets. Then, the aqueous dispersion medium is heated up to a polymerization temperature to be polymerized. If necessary, the particles are associated together and/or the polymerizable monomer is additionally added to be polymerized. Thereafter, the aqueous dispersion medium is subjected to filtration, washing, dehydration and drying to produce the toner.

As a polymerizable monomer, there can be mentioned, for instance, a monovinyl monomer, a cross-linkable monomer and a macromonomer. These polymerizable monomers become the binder resin component after polymerization.

Specific examples of the monovinyl monomers include; aromatic vinyl monomers such as styrene, vinyltoluene and a-methylstyrene; acrylic copolymers such as acrylic acid, methyl acrylate, ethyl acrylate, propyl acrylate, butyl acrulate, 2-ethylhexyl acrylate, cyclohexyl acrylate and isobonyl acrylylate; methacrylic copolymers such as methacrylic acid, methyl methacrylate, ethyl methacrylate, propyl methacrylate, butyl methacrylate, 2-ethlhexyl methacrylate, cyclohexyl methacrylate and isobonyl methacrylylate; and mono olefin monomers such as ethylene, propylene and butylenes; and the like.

The monovinyl monomers may be used alone or in a combination thereof. Among the monovinyl monomers as mentioned above, it is preferable to use aromatic vinyl monomers alone, or to use aromatic vinyl monomers in a combination with acrylic ester monomers or methacrylic ester monomers.

The use of the crosslinkable monomer in a combination with the monovinyl monomer effectively improves hot offset resistance of the resulting toner. The crosslinkable monomer is a monomer having two or more vinyl groups. As specific examples of the crosslinkable monomer, there can be mentioned; divinylbenzene, divinylnaphthalene, ethlenglycol dimethacrylate, pentaerythritol triallyl ether and trimethylolpropane triacrylate. These crosslinkable monomers may be used alone or in a combination thereof. An amount of the crosslinkable monomer is generally 10 parts by weight or less, preferably from 0.1 to 2 parts by weight, per 100 parts by weight of the monovinyl monomer.

It is preferable to use a macromonomer together with the monovinyl monomer because this use provides a satisfactory balance between storage stability and fixing ability at a low temperature. The macromonomer is an oligomer or polymer having a polymerizable carbon-carbon unsaturated double bond at its molecular chain terminal and a number average molecular weight generally from 1,000 to 30,000.

The macromonomer is preferably the one which gives a polymer having a glass transition temperature higher than that of a polymer obtained by polymerizing the above-mentioned monovinyl monomer alone.

An amount of the macromonomer used is generally from 0.01 to 10 parts by weight, preferably from 0.03 to 5 parts by weight, more preferably from 0.05 to 1 part by weight, per 100 parts by weight of the monovinyl monomer.

As examples of the polymerization initiator, there can be mentioned; persulfates such as potassium persulfate and ammonium persulfate; azo compounds such as 4,4′-azobis-(4-cyanovaleric acid), dimethyl 2,2′-azobis (2-methylpropyonitrile), 2,2′-azobis-(2-methyl-N-(2-hydroxyethyl))propionamide, 2,2′-azobis-(2-amidinopropane) dihydrochloride, 2,2′-azobis-(2,4-dimethyl valeronitrile) and 2,2′-azobis-isobutyronitrile; and peroxides such as di-t-butyl peroxide, benzoyl peroxide, t-butyl peroxy-2-ethylhexanoate, t-hexyl peroxy-2-ethylhexanoate, t-butyl peroxypivalate, di-isopropyl peroxydicarbonate, di-t-butyl peroxyisophthalate, and t-butyl peroxyisobutyrate. Redox initiators, composed of combinations of these polymerization initiators with a reducing agent, may also be used. Among the polymerization initiators, dimethyl 2,2′-azobis (2-methylpropyonitrile) is preferred.

An amount of the polymerization initiator used in the polymerization of the polymerizable monomer is preferably from 0.1 to 20 parts by weight, more preferably from 0.3 to 15 parts by weight, most preferably from 0.5 to 10 parts by weight, per 100 parts by weight of the polymerizable monomer. The polymerization initiator may be added to the polymerizable monomer composition in advance or may be added to an aqueous dispersion medium after forming droplets depending on conditions.

As the dispersion stabilizer, there can be mentioned; a metallic compound such as sulfates such as barium sulfate and calcium sulfate; carbonates such as barium carbonate, calcium carbonate and magnesium carbonate; phosphates such as calcium phosphate; and metal oxides such as aluminum oxide and titanium oxide; and besides, metallic hydroxides such as aluminum hydroxide, magnesium hydrate and ferric hydroxide; water-soluble polymers such as polyvinyl alcohol, methyl cellulose and gelatin; anionic surfactants; nonionic surfactants; and amphoteric surfactants. The aforesaid dispersion stabilizer may be used alone or in combination of two kinds thereof.

Among the above dispersion stabilizers,a dispersion stabilizer containing colloid of the metallic compound, especially a hardly water-soluble inorganic hydroxide is preferred, since it can narrow the particle size distribution of a colored resin particles; the remaining amount of the dispersion stabilizer after washing is small; and it can clearly reproduce images. The colloid of the hardly water-soluble metallic hydroxide preferably has a particle diameter (Dp50) of 0.5 μm or less, the particle diameter (Dp50) representing a particle diameter at which a volume cumulative total calculated from small particle diameter side in a number particle diameter distribution is 50%, and a particle diameter (Dp90) of 1 μm or less is preferable, the particle diameter (Dp90) representing a particle diameter at which the mentioned volume cumulative total calculated from small particle diameter side is 90%. If the particle diameter of the colloid is too great, the stability of the polymerization may be broken, and the stability of the resulting toner may be deteriorated.

An amount of the above described dispersion stabilizer is preferably from 0.1 to 20 parts by weight relative to 100 parts by weight of the polymerizable monomer. If the amount of the dispersion stabilizer is lower than 0.1 parts by weight, it is difficult to achieve sufficient polymerization, so that polymerization aggregates are easy to be formed. On the other hand, if the amount exceeds 20 parts by weight, the particle diameter of the colored resin particle after the polymerization becomes too small to put it in practical use.

Further, upon polymerization, a molecular weight modifier is preferably used. As the molecular weight modifier, there can be mentioned; mercaptans such as t-dodecyl mercaptan, n-dodecyl mercaptan, n-octyl mercaptan and 2,2,4,6,6-pentamethylheptane-4-thiol and the like. The molecular weight modifier may be added before or during polymerization reaction. An amount of the molecular weight modifier is preferably from 0.01 to 10 parts by weight, more preferably from 0.1 to 5 parts by weight, per 100 parts by weight of the polymerizable monomer.

A method for producing the core-shell structured colored resin particles is not limited, and these colored resin particles can be produced by a publicly known method. For example, a method such as spray-drying method, interfacial reaction method, in-situ polymerization method, or phase separation method may be named. Specifically, colored resin particles obtained by pulverization, polymerization, association or phase inversion emulsification as core particles are covered with a shell layer to prepare core-shell structured colored resin particles. Of these methods, the in-situ polymerization method and phase-separation method are preferable because of their efficient productivity.

The method for producing the core-shell structured colored resin particles using the in-situ polymerization process is described in detail below.

A polymerizable monomer to form a shell (polymerizable monomer for shell) and a polymerization initiator are added to an aqueous dispersion medium including core particles dispersed therein, and the mixture is polymerized to obtain the core-shell structured colored resin particles.

As specific examples of the process for forming the shell, there can be mentioned; a process comprising adding a polymerizable monomer for a shell to a reaction system of a polymerization reaction which has been conducted for preparing core particles to continuously conduct polymerization; and a process comprising introducing core particles prepared in a different reaction system and adding a polymerizable monomer for a shell thereto to conduct polymerization.

The polymerizable monomer for shell may be provided into the reaction system at one time, or may be provided continuously or dividedly using a pump such as a plunger pump.

As the polymerizable monomer for shell, monovinyl monomers capable of forming a polymer having a glass transition temperature of higher than 80° C. by polymerization, such as styrene, acrylonitrile and methyl methacrylate, may be used in a combination of hydrophilic multifunctional polymerizable monomer such as triethyleneglycol diacrylate, 1,6-hexanediol acrylate, EO adduct diacrylate of bisphenol A, trimethylolpropane triacrylate and the like so that the obtained polymer shall have a glass transformation temperature from 60 to 110° C., more preferably from 80 to 105° C.

An amount of the polymerizable monomer for shell is generally from 0.1 to 10 parts by weight, preferably from 0.5 to 5 parts by weight, more preferably from 1 to 3 parts by weight, to 100 parts by weight of the monovinyl monomer used for obtaining the polymerizable monomer for core.

The aforesaid monovinyl monomer and hydrophilic multifunctional polymerizable monomer may be used alone or in a combination thereof. And, a used amount ratio of the monovinyl monomer to the hydrophilic multifunctional polymerizable monomer is preferably 1:5 to 5:1. If the amount ratio of the monovinyl monomer to the hydrophilic multifunctional polemerizable monomer is within this range, the toner for developing electrostatic latent image which is composed of the colored resin particle thus obtained can have improved storage stability and flowability, and lower deterioration of image quality due to environmental variation.

When the polymerizable monomer for shell is added to the reaction system, a water-soluble polymerization initiator is preferably added because this addition makes it easy to obtain the core-shell structured colored resin particles. It is speculated that when the water-soluble polymerization initiator is added during addition of the polymerizable monomer for shell, the water-soluble polymerization initiator migrates to the vicinity of an outer surface of a core particle changed from the polymerizable monomer for shell, thereby facilitating forming the polymer (shell) on the surface of the core particle.

As the water-soluble polymerization initiator; there can be mentioned; persulfates such as potassium persulfate, and ammonium persulfate; azo compounds such as 2,2′-azobis-(2-methyl-N-(2-hydroxyethyl)propionamide), and 2,2′-azobis-(2-methyl-N-(1,1-bis(hydroxymethyl)-2-hyd roxyethyl)propionamide. An amount of the water-soluble polymerization initiator is generally from 0.1 to 50 parts by weight, preferably from 1 to 30 parts by weight, per 100 parts by weight of the polymerizable monomer for shell.

A temperature during polymerization is preferably 50° C. or higher, more preferably from 60 to 95° C. A polymerization reaction time is preferably from 1 to 20 hours, more preferably from 2 to 10 hours. After completion of the polymerization, a procedure comprising filtration, washing and dehydration is preferably repeated several times, as desired after that dry, in accordance with the conventional methods.

In the aqueous dispersion of the colored resin particles obtained by the polymerization, if an inorganic compound such as inorganic hydroxide is used as the dispersion stabilizer, the dispersion stabilizer is preferably dissolved in water and removed by adding acid or alkali. If colloid of a hardly water-soluble inorganic hydroxide is used as the dispersion stabilizer, it is preferable to add acid so that pH of the aqueous dispersion is pH6.5 or lower. As the acid to be added, an inorganic acid such as sulfuric acid, hydrochloric acid or nitric acid; or an organic acid such as formic acid or acetic acid; can be used. Sulfuric acid is particularly preferable because it has a high efficiency of its removal and its burden on production facilities is light.

There is no limitation on the method of filtering toner particles from the aqueous dispersion medium for dehydration. For example, centrifugal filtration, vacuum filtration or pressurized filtration can be named. Of these methods, centrifugal filtration is preferable.

The toner for developing electrostatic latent image according to the present invention comprises at least a colored resin particle and an external additive, and is obtained by mixing the colored resin particles and the external additive by means of a high speed stirrer such as a HENSCHEL mixer.

The colored resin particle (including core-shell structured colored resin particles) prepared by a polymerization method and the like can be used as a main component of various developers, preferably as a one component developer, more preferably as a nonmagnetic one component developer. As the external additive, the aforesaid additives may be used.

### EXAMPLES

The present invention is hereinafter to be described more specifically by the following examples. Such examples, however, are not to be construed as limiting in any way the scope of the present invention. All designations of “part” or “parts” and “%” used in the following examples mean part or parts by weight and wt. % unless expressly noted.

(1) Particle Diameter, Particle Diameter Distribution and Average Circularity

10 ml of ion-exchanged water was charged to a vessel, and 0.02 g of surfactant (alkyl benzene sodium sulfonate) as a dispersing agent and further 0.02 g of a colored resin particle are added to the vessel. Then, the mixture was subjected to a dispersing processing using an ultrasonic dispersion apparatus at 60 W for 3 minutes. A toner concentration at a measurement was adjusted to 3,000 to 10,000/μL, and then 1,000 to 10,000 of colored resin particles having a circle equivalent diameter of 1 μm or more were used for measurement using a flow type particle image analyser (“FPIA-2100”, Trade Name, manufactured by SYSMEX CORPORATIION). From the measurement, a volume average particle diameter, a particle diameter distribution, a ratio (Dv/Dp) of the volume average particle diameter to a number average particle diameter (Dp) and an average circularity were obtained.

(2) Zeta Potential

To 30 mg of a toner for developing electrostatic latent images which was left standing over a day and a night under a condition at a temperature of 23° C. and a humidity of 50%, a solvent of ethanol and ion-exchanged water (a conductivity: 0.8 μS/cm) having a volume ratio of 50:50 was added until a total weight was 100 g, and then the toner was dispersed in the solvent using an ultrasonic dispersion apparatus for 5 minutes. Then, a zeta potential of the mixture was measured using a zeta potential measurement apparatus (“zetasizer3000HS”, Trade Name, manufactured by Malvern Instrument Ltd.) at 25° C.

A zeta potential of the toner for developing electrostatic latent images just after dispersing in the solvent was measured, and the measurement was set to El. On the other hand, after leaving the toner for developing electrostatic latent images under a condition at a temperature of 50° C. and a humidity of 80% for two weeks, a zeta potential E2 of the toner was measured by the same manner as the aforesaid El, and the measurement was set to E2.

(3) Conductivity

6 g of toner for developing electrostatic latent images was dispersed in ion-exchanged water (al being 0.8 μS/cm; pH=7) to prepare 100 g of a dispersion. After heating and boiling the dispersion and maintaining the boiling state for about 10 minutes (10 minute boiling), ion-exchanged water (al being 0.8 μS/cm; pH=7) which was separately boiled for 10 minutes was supplied thereto up to the pre-boiling volume. The resultant was cooled to the room temperature (about 22° C.) and the conductivity σ2 of the extracted liquid was measured. The conductivity σ1 of the ion exchange water used was measured to calculate σ2-σ1. Conductivities were measured using Conductivity Meter “ES-12” (Trade Name, manufactured by Horiba Ltd.)

(4) Measurement of Acid Value of Soluble Component in Tetrahydrofuran

About 2 g of the toner for developing electrostatic latent images was weighted and charged in a 200 ml conical flask, and 80 ml of tetrahydrofuran (THF) was added the flask and then the mixture solution was stirred for 1 hour to dissolve the toner. The mixture solution was subjected to an ultrasonic processing using an ultrasonic washing machine having an output power of 20 W for 10 minutes. Then, the mixture solution was filtrated by suction using a filter paper (GFP, Filter paper for KIRIYAMA ROHTO, retention particle: 0.8 μm). At the same time, the filtrated solution after washing the conical flask with 10 ml of THF was filtrated by suction using the aforesaid filter paper. Furthermore, the filtration was filtrated using a filter paper of 0.45 μm. In the same manner, a solution after washing a suction bottle with 10 ml of THF was filtrated using a filter paper to set the total weight to 100 ml. Then, a few drops of phenolphthalein used as an indicator was added to the filtration, and the filtration was titrated with potassium hydroxide-ethanol solution of 0.01 mol/L to obtain an acid value.

(5) Image Density

Copy papers were set in a commercially available non-magnetic-one-component developing type printer (printing speed: 18-A4 size sheet/min), and the toner for developing electrostatic latent images was put in a developing device of the printer and an amount of the toner supplied on a developing roll of the printer was adjusted to the range of 0.40 to 0.45 mg/cm². The toner was left standing over a day and a night under an (N/N) environment at a temperature of 23° C. and a humidity of 50%. Then, 10 papers printing was continuously performed at an image density of 5%. And then, a solid image was printed. And, an image density of the printed solid image was measured using a Macbeth type reflective image density measuring apparatus. In the same manner, after leaving the toner for developing electrostatic latent images under a condition at a temperature of 50° C. and a humidity of 80% for 2 weeks, the toner was put in the developing device for measuring image density.

(6) Fog

The toner for developing electrostatic latent images was put in a developing device of the printer used in (5), and the printer left standing under a condition at a temperature of 50° C. and a humidity of 80% for 2 weeks. Printing was continuously performed at an image density of 5%. And, at every 500 papers printing, a printing of plain pattern was performed. During the printing of plain pattern, the printing was stopped, and the toner developed a non-image on the photoconductive member after developing was stripped of f and collected by sticking with an adhesive tape (Scotch Mending Tape 810-3-18, Trade Name, manufactured by Sumitomo 3M Limited). Then the adhesive tape was stuck on a new sheet of paper to measure whiteness (B) using a whiteness meter (manufactured by Nippon Denshoku Industries Co., Ltd.). At the same time, as a reference, an unused adhesive tape was stuck on the same new sheet of paper to measure whiteness (A), and the difference (A-B) in the whitenesses A and B was set to the fog (%). And, a number of the continuously printed paper having the fog of 1% or less was checked. Final number of the paper was set to 10,000. The samples having 10,000 or more in a table show that the aforesaid image quality is kept even after 10,000 papers printing.

(7) Storage Stability (Blocking Resistance)

The toner for developing electrostatic latent image was left standing under a condition at a temperature of 50° C. and a humidity of 80% for 2 weeks. Then, the toner was taken out of the condition so as not to destroy the aggregate structure of the toner and carefully transferred to a sieve having an aperture size of 500am. The sieve on which the toner was transferred was vibrated for 30 seconds with the use of a powder measuring device (“POWDER TESTER PTR”, Trade Name, manufactured by Hosokawa Micron Corporation) under a condition of vibration amplitude of 1.0 mm. Then, the weight of the toner remaining on the sieve was measured, and the measured value was taken as the weight of the aggregated toner. The proportion of the weight (wt. %) of the aggregated toner to the weight of the toner initially placed in the container was calculated. The measurement was made three times for one sample, and the average of the measured values was obtained and used as an index of storage stability. The storage stability of the toner is better as it shows a smaller value (wt. %).

(8) Flowability

The toner for developing electrostatic latent image was left standing at a condition at a temperature of 50° C. and a humidity of 80% for 2 weeks. Three sieves with aperture sizes of 150 μm, 75 μm and 45 μm, respectively, were stacked, in this order with the 150 μm sieve laid at the top. A sample (the negative charged toner for developing an electrostatic latent image), 4 g was accurately weighed and placed on the sieve at the top. Then, the three stacked sieves were vibrated for 15 seconds with vibration amplitude of 0.7 mm with the use of a powder measuring device (trade name: Powder Tester, manufactured by Hosokawa Micron Ltd.), and then the weight of the toner for developing an electrostatic latent image remaining on each sieve was measured. The measured values were substituted into the following equations for calculation to determine values of flowability. The measurement was made three times for one sample, and the average of the measured values was obtained. Equations for calculation:
a=(weight (g) of the toner for developing an electrostatic latent image remaining on the sieve of the aperture size 150 μm)/4 (g)×100;
b=(weight (g) of the toner for developing an electrostatic latent image remaining on the sieve of the aperture size 75 μm)/4 (g)×100×0.6;
c=(weight (g) of the toner for developing an electrostatic latent image remaining on the sieve of the aperture size 45 μm)/4 (g)×100×0.2; and
Flowability (%)=100−(a+b+c).
(9) Fixing Temperature of Toner for Developing Electrostatic Latent Image

A fixing test was conducted using the printer used in (5) modified such that the temperature of its fixing roll portion would be variable. The fixing test was performed by varying the temperature of the fixing roll of the modified printer by 5° C. at a time, and measuring the fixing rate of the developer at each temperatures to determine the relationship between the temperature and the fixing rate. The fixing rate was calculated from the ratio of image density after a tape peeling treatment to that before the treatment in a black solid printing area in a test sheet printed by the modified printer. That is, the fixing rate was calculated from the following equation:
Fixing rate (%)=(ID_{After}/ID_{Before})×100 where ID_{Before} represents the image density before tape peeling, and ID_{After} represents the image density after tape peeling.

The tape peeling treatment means a series of steps consisting: applying an adhesive tape( Scotch Mending Tape 810-3-18, manufactured by Sumitomo 3M Limited) to a portion of the test sheet to be measured, pressing the adhesive tape by a 500 g steel roller for adhesion, and then peeling the adhesive tape at a constant speed in a direction along the sheet. The image density was measured by use of a Macbeth's reflection type image density measuring device. The toner fixing temperature denotes the temperature of the fixing roll at which the fixing rate became 80% in the fixing test.

(10) Hot-Offset Temperature

As in the measurement of the toner fixing temperature in test (9), the temperature of the fixing roll was varied by 5° C. at a time, and printing was done at each temperature. Hot offset resistance denotes the temperature at which the toner becomes to remain on the fixing roll to generate soil.

### PRODUCTION EXAMPLE 1

### Preparation of Negative Charge Control Resin Compound A

100 parts of charge control resin (a weight average molecular weight: 31,000, a number average molecular weight: 8,000, an acid value:7.1 mgKOH/g, glass transition temperature: 62° C.) obtained by polymerizing 82% of styrene, 16% of butylacrylate and 2% of 2-acrylamid-2-methylpropanesulfonate was dispersed into 24 parts of methyl ethyl ketone and 6 parts of methanol. And, the dispersion was mixed by rolls under cooling. After the resulting mixture was winded on the roll, 100 parts of cyan pigment (“ C.I. pigment blue 15-3”, Trade Name, manufactured by Clariant Co.) was gradually added and stirred for one hour to prepare a charge control resin composition A. During this period, the clearance between the rolls was initially 1 mm, broadened gradually, to finally to 3 mm, and an organic solvent (a solvent mixture of methyl ethyl ketone/methanol=4/1) was added occationally according to mixing and kneading condition of the charge control resin composition. After the stirring, the organic solvent added was removed under reduced pressure.

### PRODUCTION EXAMPLE 2

### Preparation of Negative Charge Control Resin Compound B

In the same manner as in the preparation example 1 except that a negative charge control resin (a weight average molecular weight: 22,000, a number average molecular weight: 7,000, an acid value: 3.2 mgKOH/g, a glass transfer temperature: 60° C.) produced by a polymerization of 82% of styrene, 17% of butylacrylate and 1% of 2-acrylamid-2-methylpropanesulfonate was used, a negative charge control resin composition B was obtained.

### PRODUCTION EXAMPLE 3

### Preparation of Negative Charge Control Resin Compound C

In the same manner as in the preparation example 1 except that a negative charge control resin (a weight average molecular weight: 10,000, a number average molecular weight: 6,000, an acid value: 21 mgKOH/g, a glass transfer temperature: 71° C.) produced by a polymerization of 82% of styrene, 11% of butylacrylate and 7% of 2-acrylamid-2-methylpropanesulfonate was used, a negative charge control resin composition C was obtained.

### EXAMPLE 1

An aqueous solution containing 6.9 parts of sodium hydroxide (alkali metal hydroxide) dissolved in 50 parts of ion-exchanged water was gradually added to an aqueous solution containing 9.8 parts of magnesium chloride (water-soluble polyvalent metallic salt) dissolved in 250 parts of ion-exchanged water, with stirring, to prepare a magnesium hydroxide colloidal dispersion (colloid of hardly water-soluble metal hydroxide). A number average particle diameter D50 (a number cumulative total value calculated from small particle diameter in the particle diameter distribution is 50%) and a number average particle diameter D90 (a number cumulative total value calculated from small particle diameter in the particle diameter distribution is 90%) of the formed colloid were measured using a particle diameter distribution measurement apparatus (“SALD2000A”, Trade Name, manufactured by Shimadzu Corporation). The measurement using the particle diameter distribution measurement apparatus was performed under a condition of a refractive index of 1.55-0.20i, an ultrasonic irradiation period of 5 minutes and a dispersion medium of 10% salt solution used for measuring droplets.

A polymerizable monomer composition for core composed of 80.5 parts of styrene and 19.5 parts of butyl acrylate, 12 parts of master batch of the negative charge control resin composition obtained in the production example 1, 3 parts of t-dodecyl mercaptan, 10 parts of pentaerythritol tetrastearate (a hydroxyl value:2.0 mgKOH/g), 0.5 parts of divinylbenzene and 0.8 parts of polymethacrylic ester macromonomer (“AA6”, Trade Name, manufactured by Toagosei Chemical Industry Co., Ltd.) were stirred and mixed to disperse uniformly to obtain a monomer composition for core.

On the other hand, 2 parts of methyl methacrylate, 1 parts of EO adduct diacrylate of bisphenol A (“LIGHTACRYLATE BR-4EA”, Trade Name, manufactured by Kyoei kagaku Kogyo Co., Ltd.) and 100 parts of water were mixed to obtain an aqueous dispersion of the polymerizable monomer composition for shell.

The polymerizable monomer composition for core was added to the colloidal dispersion of magnesium hydroxide obtained above, and the mixture was stirred until droplets stabilized. After the droplets stabilized, 6 parts of t-butyl peroxy-2-ethylhexanoete (“PERBUTYL O”, Trade Name, manufactured by NOF CORPORATION) was added to the mixture, and then the mixture was stirred at 15,000 rpm under shearing force using a Ebara Milder (“MDN303V”, Trade Name, manufactured by Ebara Corporation) to form droplets of the polymerizable monomer composition for core. The thus-formed aqueous dispersion containing the polymerizable monomer composition mixture was charged into a reactor equipped with an agitating blade, and heated so that a temperature was controlled at 90° C. to initiate a polymerization reaction. At the time when the conversion of the monomer into a polymer reached almost 100%, an aqueous dispersion of the polymerizable monomer for shell and 0.2 parts of water-soluble polymerization initiator (“VA-086”, Trade Name, manufactured by Wako Pure Chemical Industries, Ltd.,) (2,2′-azobis-(2-methyl-N-(2-hydroxyethyl))propionamid e) dissolved in 65 parts of distilled water were charged into the reactor. After the polymerization reaction for 4 hours, the reaction was stopped to obtain an aqueous dispersion of colored resin particles having a pH of 9.5.

While stirring the aqueous dispersion of colored resin particle thus prepared, the pH of the system was adjusted to 5 or lower using sulfuric acid to be subjected to acid washing. After the aqueous dispersion was filtered to separate water, 500 parts of ion-exchanged water was newly added thereto to form a slurry again to subject to water washing. Thereafter, the dehydration and water washing were repeatedly performed several times, and solids contained in the solution was separated by filtration and dried at 45° C. for two days and night using a dryer to prepare colored resin particles. The colored resin particles thus obtained had a volume average particle diameter (Dv) of 7.4μm, a particle diameter distribution (Dv/Dp) of 1.23 and an average circularity of 0.970.

To 100 parts of the colored resin particles obtained above, there was added 0.5 part of silica fine particle having a degree of hydrophobicity of 65% and a number average particle diameter of primary particles of 12 nm,2 parts of silica fine particle having a degree of hydrophobicity of 64% and a number average particle diameter of primary particles of 40 nm were added, and mixed for 10 minutes at 1,400 rpm using HENSCHEL MIXER to prepare toner for developing electrostatic latent image. Property of the toner and image quality of a printed image developed using the toner were evaluated according to the above-mentioned manner. The results were shown in table 1.

### EXAMPLE 2

Colored resin particles having a volume average particle diameter (Dv) of 6.7 μm, a particle diameter distribution (Dv/Dp) of 1.22 and an average circularity of 0.973 was prepared in the same manner as in Example 1 except that the negative charge control resin A prepared in Preparation Example 1 was changed to the negative charge control resin composition B prepared in Preparation Example 2.

The obtained colored resin particle was processed in the same manner as in Example 1 to obtain a toner for developing electrostatic latent images. Property of the toner and image quality of a printed image developed using the toner were evaluated in the same manner as in Example 1. The results are shown in table 1.

### COMPARATIVE EXAMPLE 1

A monomer composition for core was prepared in the same manner as in Example I except that the negative charge control resin A prepared in Preparation Example 1 was changed to the negative charge control resin composition C prepared in Preparation Example 3. Colored resin particles having a volume average particle diameter (Dv) of 7.1 μm, a particle diameter distribution (Dv/Dp) of 1.25 and an average circularity of 0.965 was prepared in the same manner as in Example 1 except that 1 parts of EO adduct diacryrate of bisphenol A was not used as a monomer for shell.

The obtained colored resin particle was processed in the same manner as in Example 1 to obtain a toner for developing electrostatic latent images. Property of the toner and image quality of a printed image developed using the toner were evaluated in the same manner as in Example 1. The results are shown in table 1.

### COMPARATIVE EXAMPLE 2

80 parts of styrene, 20 parts of n-butylacryrate, 6 parts of cyan pigment (C.I. Pigment blue 15-3, manufactured by Clariant Co.), 0.5 parts of negative charge control resin (produced by a polymerization of 86% of styrene, 9% of butyl acrylate and 5% of 2-acrylamid-2-methylpropane sulfonic acid, a weight average molecular weight: 16,000, a number average molecular weight: 10,000, an acid value: 15 mgKOH/g, a glass transfer temperature: 76° C.), 0.6 part of divinyl benzene, 1 parts of t-dodecyl mercaptane and 2 parts of sasol wax (“PARAFLINT SPRAY 30”, Trade Name, manufactured by Sasol Co. Ltd.) were dispersed using a beadmil under a room temperature to obtain a uniformly mixed solution. While stirring the mixed solution, 5 parts of a polymerization initiator (“PERBUTYL 0”, Trade Name, manufactured by NOF CORPORATION) was added to the mixed solution and the mixed solution was stirred until droplets became uniform to obtain a polymerizable monomer composition.

On the other hand, to an aqueous solution of 250 parts of ion-exchanged water in which 9.5 parts of magnesium chloride (water soluble polyvalent metal salt), another aqueous solution of 50 parts of ion-exchanged water in which 6.8 parts of sodium hydroxide (alkali hydroxide metal) was dissolved was gradually added under stirring to prepare a dispersion of magnesium hydroxide colloid (hardly water-soluble metal hydroxide colloid). The polymerizable monomer composition was added to the colloid, and the mixture was stirred under high shearing force using TK homomixer at 12,000 rpm to form droplets of the polymerizable monomer composition mixture. An aqueous dispersion of the polymerizable monomer composition mixture was charged into a reactor equipped with an agitating blade to initiate a polymerization reaction at 90° C. After performing the polymerization reaction for 8 hours, the reactor was cooled to obtain an aqueous dispersion of polymer particles.

While stirring the aqueous dispersion of colored resin particle thus prepared, the pH of the system was adjusted to 4 or lower using sulfuric acid to be subjected to acid washing. After the aqueous dispersion was filtered to separate water, 500 parts of ion-exchanged water was newly added thereto to form a slurry again to subject to water washing. Thereafter, the dehydration and water washing were repeatedly performed several times, and solids contained in the solution was separated by filtration and dried at 45° C. for two days and night using a dryer to prepare colored resin particles.

The obtained colored resin particle was processed in the same manner as in Example 1 to obtain a toner for developing electrostatic latent images. Property of the toner and image quality of a printed image developed using the toner were evaluated in the same manner as in Example 1. The results are shown in table 1.

TABLE 1

| Properties of toner | Ex. 1 | Ex. 2 | Com. Ex. 1 | Com. Ex. 2 |
|---|---|---|---|---|
| Volume average particle | 7.4 | 6.7 | 7.1 | 7.5 |
| diameter (μm) | | | | |
| Particle diameter | 1.23 | 1.22 | 1.25 | 1.27 |
| distribution (Dv/Dp) | | | | |
| Average circularity | 0.970 | 0.973 | 0.965 | 0.962 |
| E1 (mV) | −27.6 | −22.9 | −31.2 | −21.2 |
| E2 (mV) | −23.1 | −19.9 | −24.6 | −15.7 |
| Difference between E1 and E2 | 4.5 | 3.0 | 6.6 | 6.5 |
| σ2 − σ1 | 3.9 | 3.1 | 3.7 | 3.6 |
| Acid value of solble | 1.31 | 0.41 | 4.04 | 0.88 |
| component in THF (mgKOH/g) | | | | |
| Hydroxyl value of parting | 2.0 | 2.0 | 8.1 | 0 |
| agent (KOH/mg[a]) | | | | |
| Added weight of parting | 10 | 10 | 10 | 2 |
| agent [b] | | | | |
| a × b | 20 | 20 | 81 | 0 |
| Image properties | | | | |
| Image density (N/N) | 1.62 | 1.52 | 1.60 | 1.38 |
| after leaving for 2 weeks | 1.47 | 1.45 | 1.35 | 1.20 |
| Fog | 10,000 | 10,000 | 8,500 | 9,000 |
| Storage stability | 2 | 3 | 20 | 35 |
| Flowability | 95 | 93 | 75 | 65 |
| Fixing temperature (° C.) | 130 | 130 | 130 | 140 |
| Hot-offset temperature (° C.) | 200 | 200 | 195 | 190 |

The results of the evaluation of the toners shown in the table 1 shows the following facts.

The toners for developing electrostatic image in Comparative Example 1 and Comparative Example 2 have a difference out of the range according to the present invention between a zeta potential (E1) and a zeta potential (E2). Here, the zeta potential (E1) shows a zeta potential of each of the toner after leaving for one day and night under a condition at a temperature of 23° C. and a humidity of 50%, and the zeta potential (E2) shows a potential of each of the toner after leaving for 2 weeks under a condition at a temperature of 50° C. and a humidity of 80%. The toners for developing electrostatic image in Comparative Example I and Comparative Example 2 provide low image density and insufficient storage stability and flowability.

On the contrary, the toners for developing electrostatic image in Example 1 and Example 2 according to the present invention provides high image density and excellent durability against environment, storage stability and flowability even if the toners are left under a condition at a temperature of 50° C. and a humidity of 80% for 2 weeks.

### INDUSTRIAL APPLICABILITY

According to the present invention, there are provided toners for developing electrostatic images, which forms images without losing quality due to environmental changes and also has excellent storage stability and flowability.

1. A toner for developing an electrostatic latent images comprising colored resin particles containing at least a binder resin and a colorant,
wherein said colored resin particles have a volume average particle diameter (Dv) in the range from 4 to 10 m and an average circularity in the range from 0.930 to 0.995 and,
a zeta potential (E1) of the toner after laid still under a condition at the temperature of 23° C. and the humidity of 50% for one day and night is in the range from −50 to −10 mV and
a difference is less than 5 mV between a zeta potential (E2) of the toner after laid still under a condition at the temperature of 50° C. and the humidity of 80% for two weeks and E1.

2. The toner for developing the electrostatic latent images according to claim 1,
wherein the toner has the zeta potential (E1) in the range from −40 to −20 mV.

3. The toner for developing the electric images according to claim 1,
wherein the difference between E2 and E1 is less than 3 mV.

4. The toner for developing the electrostatic latent image according to claim 1,
wherein soluble component in tetrahydrofran of the toner for developing the electrostatic latent images has an acid value of 4 mgKOH/g or less.

5. The toner for developing the electrostatic latent images according to claim 1,
wherein the colored resin particles further containing multifunctional ester compound having a hydroxyl value (a) of 4 mgKOH/g or less as a parting agent, in which a product of an added amount (b) of the parting agent per 100 parts of the binder resin and the hydroxyl value (a) is 40 or less.

6. The toner for developing the electrostatic latent image according to claim 5,
wherein the product of (a) and (b) is 30 or less.

7. The toner for developing the electrostatic latent images according to claim 1,
wherein the toner has the ratio (Dv/Dp) of the volume average particle diameter (Dv) to a number average particle diameter (Dp) in the range from 1.0 to 1.3.

8. The toner for developing the electrostatic latent images according to claim 1, further containing a charge control agent.

9. The toner for developing the electrostatic latent images according to claim 8,
wherein the charge control agent is a charge control resin having a number average molecular weight of 3,000 to 30,000.

10. The toner for developing the electrostatic images according to claim 8,
wherein the charge control agent is a charge control resin having an acid value in the range from 0.03 to 15 mgKOH/g.

11. The toner for developing the electrostatic latent image according to claim 5,
wherein the parting agent is a synthetic wax or a multifunctional ester compound.

12. The toner for developing the electrostatic latent image according to claim 1,
wherein an extract liquid with water from the toner has an electric conductivity σ2 of 20 μS/cm or less, in which the extracted liquid with water is obtained in the manner such that the toner is dispersed into an ion-exchanged water having an electric conductivity σ1 so that a concentration of the toner is 6% by weight, the resultant toner dispersion is heated to the boil for 10 minutes, another ion-exchanged water having an electric conductivity al is added to the resultant toner dispersion to the amount of vaporized water to return the capacity of the toner dispersion to the capacity before the boil, and then the resultant toner dispersion is cooled down to the room temperature (about 25° C.).

13. The toner for developing the electrostatic latent image according to claim 12,
wherein the σ2 is less than 10 μS/cm.

14. The toner for developing the electrostatic latent image according to claim 12,
wherein σ2-σ1 is less than 10 μS/cm.

15. The toner for developing the electrostatic latent image according to claim 12,
wherein σ2-σ1 is less than 6 μS/cm.
